(19) United States
(12) Patent Application Publication
(10) Pub. No.: US 2012/0267220 A1
(43) Pub. Date: Oct. 25, 2012

(54) WARNING DEVICE AND CABINET USING SAME

(75) Inventors: XUN-CHUN QIU, Shenzhen City (CN); RONG HU, Shenzhen City (CN); XIAO-QING YI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/172,853

(22) Filed: Jun. 30, 2011

(30) Foreign Application Priority Data
Apr. 22, 2011 (CN) 201110101750.4

(51) Int. Cl. H01H 3/16

(52) U.S. Cl. 200/61.43; 200/61.42

(57) ABSTRACT

A warning device includes a main body, a touching switch, and a pressure element. The main body includes a first and a second end surfaces opposite to each other, and defines a receiving room penetrating through the first and second end surfaces. The touching switch is received in the receiving room and includes two spaced pins, an operation pole, and a metal sheet. The operation pole protrudes from the first end surface. The metal sheet is positioned on one end of the operation pole and connected between the two pins. The pressure element includes an operation portion and a pressure portion. One end of the operation portion is connected to the pressure portion and another end is positioned on the first end surface. The pressure portion is above the operation pole. The operation portion pushes the operation pole so as to separate the metal sheet from the two spaced pins.

### BACKGROUND

1. Technical Field

The present disclosure relates to a warning device used in a cabinet.

2. Description of Related Art

Warning devices are typically used in a computer cabinet for detecting whether or not a cover of the computer cabinet is closed. Each of the warning devices generally includes an operation pole perpendicular to the cover. When the cover is closed, the operation pole is pressed to switch off the warning device. Otherwise, the warning device is switched on as a reminder that the cover is not closed.

However, if the direction of a pressure force operated on the operation pole is not parallel to an extending direction of the operation pole during the closing of the cover, the operation pole will contact with other portion of the warning device. Therefore, the warning devices will be easily damaged.

Therefore, it is desirable to provide a warning device, which can overcome the limitations described.

### BRIEF DESCRIPTION OF THE DRAWINGS

FIG. 1 is an isometric view of a warning device in accordance with an exemplary embodiment.

FIG. 2 is a cross-sectional view of a touching switch of the warning device of FIG. 1.

FIG. 3 is an assembled view of a cabinet using the warning device of FIG. 1.

### DETAILED DESCRIPTION

Embodiments of the disclosure will now be described in detail, with reference to the accompanying drawings.

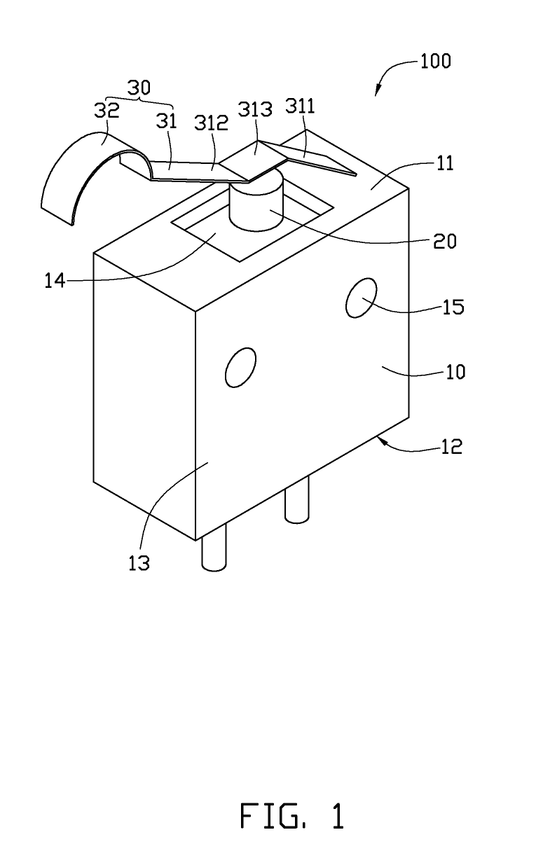

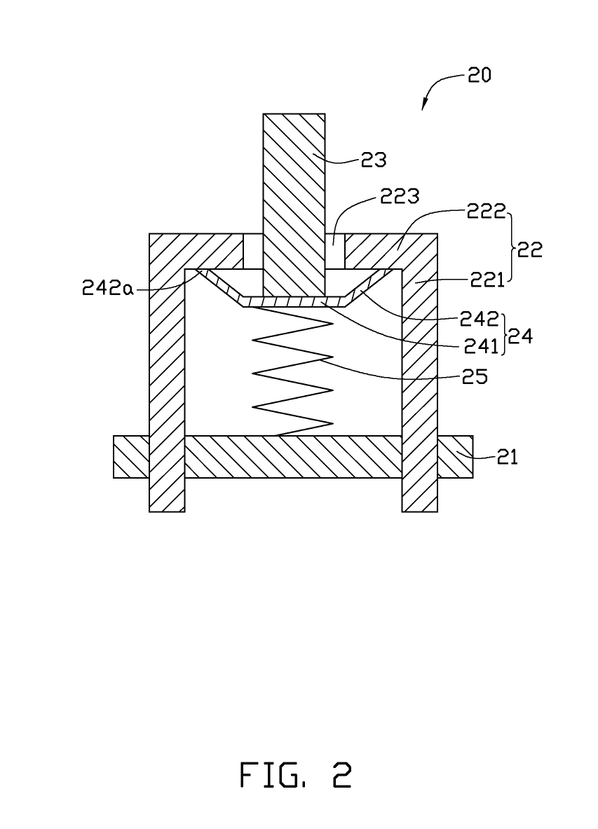

Referring to FIGS. 1-2, a warning device 100, according to an exemplary embodiment, includes a main body 10, a touching switch 20, and a pressure element 30.

The main body 10 is rectangular shaped, and includes a first end surface 11 a second end surface 12, and two opposite side surfaces 13. The second end surface 12 is opposite to the first end surface 11. The two opposite side surfaces 13 are perpendicularly connected between the first end surface 11 and the second end surface 12. The main body 10 defines a receiving room 14 penetrating through the first end surface 11 and the second end surface 12, generally formed at a center thereof. The main body 10 defines two fixing holes 15 penetrating through the side surfaces 13, generally adjacent to two opposite sides, which are perpendicular to the first end surface 11. The receiving room 14 does not communicate with the two fixing holes 15.

The touching switch 20 includes a bottom plate 21, two spaced pins 22, an operation pole 23, a metal sheet 24 and a spring 25. The bottom plate 21 is flat, and made of insulating material. The two pins 22 are made of metal, and each of the pins 22 includes a fixing portion 221 and a contacting portion 222 perpendicularly extending from one end of the fixing portion 221. The two fixing portions 221 perpendicularly penetrate through the bottom plate 21 respectively. The two contacting portions 222 are opposite to each other, and cooperatively define a receiving hole 223 therebetween. The operation pole 23 is cylindrical shaped, and made of insulating material. The diameter of the operation pole 23 is less than the distance between the two contacting portions 222. The operation pole 23 is positioned between the two spaced pins 22. One end of the operation pole 23 penetrates through the receiving hole 223, and the metal sheet 24 is positioned on another end of the operation pole 23. The metal sheet 24 includes a connection portion 241 and two arms 242 connected to two opposite edges of the connecting portion 241 respectively. The two arms 242 bend to the contacting portions 222 from the two opposite edges.

Each of the arms 242 includes a free end 242a facing away the connection portion 241, the distance between two free ends 242a is greater than the distance between the two contacting portions 222 and less than the distance between the two fixing portions 221. The connection portion 241 is positioned at the end of the operation pole 23, and the metal sheet 24 is received between the two fixing portions 221. The spring 25 is compressed and connected between the connection portion 241 and the bottom plate 21.

In an initial state, the two free ends 242a of the metal sheet 24 are contacted with the two contacting portions 222 under a restoring force of the spring 25. The two pins 22 are connected to each other. When the operation pole 23 is pressed by an operation force, the two free ends 242a of the metal sheet 24 are separated from the two contacting portions 222. The two pins 22 are disconnected.

The pressure element 30 includes an operation portion 31 and a pressure portion 32 connected to the operation portion 31. The operation portion 31 includes a first bevel plate 311, a second bevel plate 312, and an operation plate 313 connected between the first bevel plate 311 and the second bevel plate 312. The pressure portion 32 is arc shaped, and one end of the pressure portion 32 is connected to one end of the second bevel plate 312 facing away from the operation plate 313.

In assembly, the touching switch 20 is received in the receiving room 14 of the main body 10. The operation pole 23 protrudes from the first end surface 11, and the two pins 22 protrude from the second end surface 12. One end of the first bevel plate 311 is fixed on the first end surface 11, the first bevel plate 311 and the first end surface 11 form an acute angle facing the operation pole 23. The operation plate 313 is parallel to the first end surface 11 and is above the operation pole 23.

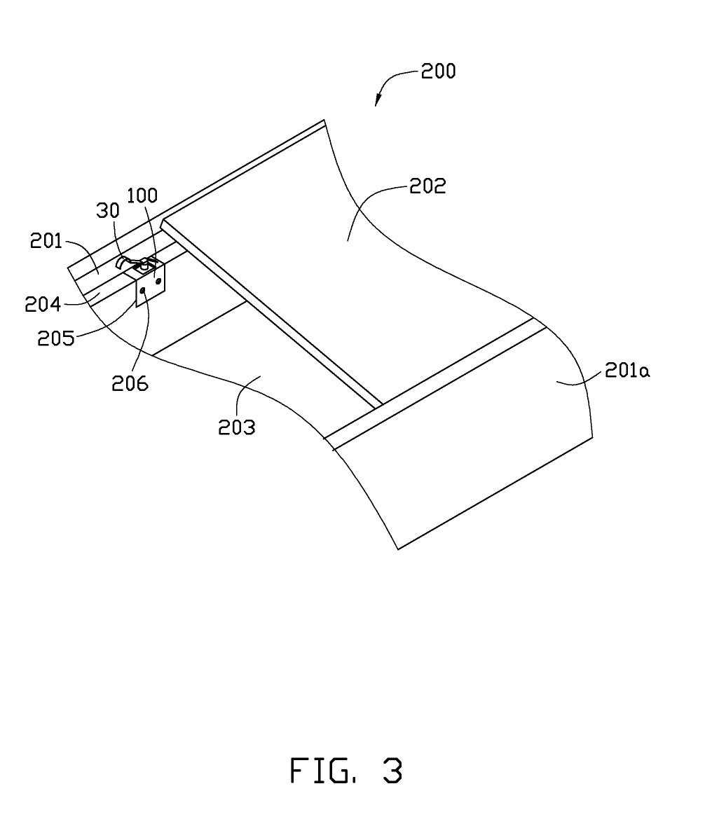

Referring to FIG. 3, a cabinet 200 using the warning device 100, according to an exemplary embodiment, includes a case 201 and a cover 202. The case 201 is rectangular shaped, and defines an opening 203 on a side thereof. The case 201 includes two opposite sidewalls 201a. The case 201 defines two stages 204 facing the opening 203 on the two sidewalls 201a. One of the stages 204 defines a receiving slot 205 for receiving the warning device 100. Two screw holes (not shown) corresponding to the fixing holes 15 are defined on an inner surface of the receiving slot 205. The warning device 100 is fixed on the cabinet 200 with two screws 206 respectively screwing through the fixing holes 15 and the screw holes. The first end surface 11 is coplanar with the stages 204. In this embodiment, one of the pins 22 is connected to a power source (not shown), and the other pin 22 is connected to an LED. In an initial state, the LED is turned on.

In use, the cover 202 is used to cover the opening 203 of the case 201. At least one pair of locking devices (not shown) are defined on the cover 202 and the case 201, for locking the cover 202 to the case 201. When the cover 202 is pressed on the pressure portion 32 of the pressure element 30, the second bevel plate 312 moves toward the first end surface 11. When the operation plate 313 contacts with the operation pole 23, the operation pole 23 is pressed down. The two arms 242 of the metal sheet 24 are separated from the two contacting portions 222. The two pins 22 are disconnected, and the LED is turned off. When the cover 202 of the cabinet 200 is opened by an external force, the two arms 242 of the metal sheet 24 are connected with the two contacting portions 222 again. The two pins 22 are connected, and the LED is turned on for reminding user that the cover 202 is open.

Particular embodiments are shown and described by way of illustration only. The principles and the features of the present disclosure may be employed in various and numerous embodiments thereof without separating from the scope of the disclosure. The above-described embodiments illustrate the scope of the disclosure but do not restrict the scope of the disclosure.

What is claimed is:

1. A warning device, comprising:
a main body comprising a first end surface and a second end surface opposite to the first end surface, the main body defining a receiving room penetrating through the first end surface and the second end surface;
a touching switch received in the receiving room and comprising two spaced pins, an operation pole, and a metal sheet, the operation pole positioned between the two spaced pins, one end of the operation pole protruding out of the first end surface, the metal sheet positioned on another end of the operation pole and connected between the two pins; and
a pressure element comprising an operation portion and a pressure portion, one end of the operation portion connected to the pressure portion and the other end fixed on the first end surface, the operation portion being above the operation pole, the operation portion being configured to push the operation pole so as to separate the metal sheet from the two spaced pins.

2. The warning device of claim 1, wherein the pressure portion is arc shaped.

3. The warning device of claim 2, wherein the operation portion comprises a first bevel plate, a second bevel plate, and an operation plate connected between the first bevel plate and the second bevel plate, one end of the first bevel plate is positioned on the first end surface, the first bevel plate and the first end surface form an acute angle facing the operation pole, the operation plate is parallel to the first end surface and is above the operation pole, the second bevel plate is connected to the pressure portion.

4. The warning device of claim 1, wherein the touching switch further comprises a bottom plate and a spring; the two pins are positioned on the bottom plate, the spring is compressed and connected between the metal sheet and the bottom plate, the metal sheet connects with the two pins under a restoring force of the spring.

5. The warning device of claim 4, wherein each of the pins comprises a fixing portion and a contacting portion perpendicularly positioned at one end of the fixing portion, the two fixing portions perpendicularly penetrate through the bottom plate, the two contacting portions are opposite to each other, and cooperatively define a receiving hole therebetween, the operation pole passes through the receiving hole.

6. The warning device of claim 5, wherein a diameter of the operation pole is less than a distance between the two contacting portions.

7. The warning device of claim 5, wherein the metal sheet comprises a connection portion and two arms connected to two opposite edges of the connecting portion respectively, the two arms bend to the contacting portions from the two opposite edges, the two arms contact the two contacting portions respectively.

8. The warning device of claim 7, wherein each of the arms comprises a free end, a distance between the two free ends is greater than the distance between the two contacting portions and less than a distance between the two fixing portion, the two free ends contact the two contacting portions respectively.

9. The warning device of claim 1, wherein the main body further comprises two opposite side surfaces perpendicularly connected between the first end surface and the second end surface; the main body defines two fixing holes penetrating through the side surfaces.

10. A cabinet, comprising:
a case comprising two opposite sidewalls and defining an opening, each of the sidewalls comprising a stage facing to the opening, one of the stages of the two sidewalls defining a receiving slot;
a warning device received in the receiving slot, and comprising:
a main body comprising a first end surface and a second end surface opposite to the first end surface, the main body defining a receiving room penetrating through the first end surface and the second end surface;
a touching switch received in the receiving room and comprising two spaced pins, an operation pole, and a metal sheet, the operation pole positioned between the two spaced pins, one end of the operation pole protruding out of the first end surface, the metal sheet positioned on another end of the operation pole and connected between the two pins; and
a pressure element comprising an operation portion and a pressure portion, one end of the operation portion connected to the pressure portion, another end of the operation portion positioned on the first end surface, the operation portion being above the operation pole; and
a cover configured for closing the opening, wherein when the cover closes the opening, the cover presses the pressure portion of the pressure element, the operation pole is pushed by the operation portion so as to separate the metal sheet from the two spaced pins.

11. The cabinet of claim 10, wherein the pressure portion is arc shaped.

12. The cabinet of claim 11, wherein the operation portion comprises a first bevel plate, a second bevel plate, and an operation plate connected between the first bevel plate and the second bevel plate, one end of the first bevel plate is positioned on the first end surface, the first bevel plate and the first end surface form an acute angle facing the operation pole, the operation plate is parallel to the first end surface and is above the operation pole, the second bevel plate is connected to the operation portion.

13. The cabinet of claim 10, wherein the touching switch further comprises a bottom plate and a spring; the two pins are positioned on the bottom plate, the spring is compressed and connected between the metal sheet and the bottom plate, the metal sheet connects with the two pins under a restoring force of the spring.

14. The cabinet of claim 13, wherein each of the pins comprises a fixing portion and a contacting portion perpendicularly positioned at one end of the fixing portion, the two fixing portions perpendicularly penetrate through the bottom plate, the two contacting portions are opposite to each other, and cooperatively define a receiving hole therebetween, the operation pole passes through the receiving hole.

15. The cabinet of claim 14, wherein a diameter of the operation pole is less than a distance between the two contacting portions.

16. The cabinet of claim 14, wherein the metal sheet comprises a connection portion and two arms connected to two opposite edges of the connecting portion respectively, the two arms bend to the contacting portions from the two opposite edges, the two arms contact the two contacting portions respectively.

17. The cabinet of claim 16, wherein each of the arms comprises a free end, a distance between the two free ends is greater than the distance between the two contacting portions and less than a distance between the two fixing portion, the two free ends contact the two contacting portions respectively.

18. The cabinet of claim 10, wherein the main body further comprises two opposite side surfaces perpendicularly connected between the first end surface and the second end surface; the main body defines two fixing holes penetrating through the side surfaces; the cabinet comprises two screws; the two screws screw through the fixing holes to secure the main body to the case.
